(19) United States
(12) Patent Application Publication
(10) Pub. No.: US 2003/0067177 A1
(43) Pub. Date: Apr. 10, 2003

(54) Spring bolt guard

(76) Inventor: Edward O'Hanlon, Tucson, AZ (US)

Correspondence Address: EDWARD O'HANLON, 3268 East 26th Street, TUCSON, AZ, 85713, US

(21) Appl. No.: 09/973,545

(22) Filed: Oct. 9, 2001

(51) Int. Cl. E05B 17/00

(52) U.S. Cl. 292/346

(57) ABSTRACT

A Spring Bolt Guard consisting of a metal or plastic ‘U’ shape with a base plate, wherein a locating screw hole has been drilled, which base plate extends out into the ‘U’ shape from the base of the ‘U’ shape such that when the described form is screwed into the spring bolt retaining cavity cut into the door frame the top of the ‘U’ shape fills the gap between the door frame and the door edge thus preventing plastic or metal shims being used to force the spring bolt back into the lock housing and by this means allowing the door to be illegaly opened without the use of a key.

### BACKGROUND OF THE INVENTION

Spring bolt locks are the most widely used locks because they provide ease of entry and exit without the use of a key. However, in their locked condition, when a key is required to open the door from the outside of the premises, other methods can be used to overcome the security provided by the lock. These methods include the use of a plastic card, such as a credit card, or a metal shim, which item is inserted into the gap between the strike plate on the door frame and the lock housing mounted on the door and which said item is then brought to bear upon the sloped side of the spring bolt in such a manner that when the plastic card, or metal shim, is pushed further into the door gap the spring of the spring bolt is overcome thus causing the spring bolt to exit from the strike plate cavity and force it back into the lock housing on the door. In this above way the door can be readily opened without the use of a key and so the security provided by the lock is compromised.

Aspring bolt guard made in accordance with this invention will prevent the spring bolt from being forced, or withdrawn, from the strike plate cavity and forced back into the lock housing by any external means, other than the key, and thus will increase the security status of the spring bolt to that of a dead bolt and yet maintain the convenience of the spring bolt lock.

### SUMMARY OF THE INVENTION

The spring bolt guard consists of a “U” shaped channel cut to such a length that it includes three (3) dimensions. These dimensions being, in the first instance, the depth of the bolt cavity cut into the door frame into which the spring bolt guard will be placed. In the second instance, it is that distance between the bolt strike plate mounted on the door frame, above the bolt cavity, and the lock mounting plate on the door edge, this distance being designated as the door gap. And, in the third and final instance, a base section by which the spring bolt guard is mounted in the bolt cavity, this base section being formed by removing the side arms of the “U” channel just beyond the distance required in the first two aforesaid instances, such that a flat section, made up of the base of the “U” shaped channel, is formed, which flat base section is bent inwards towards the remaining sides of the “U” shaped channel to further form a base section which is used to mount the spring bolt guard to the bottom of the bolt cavity by means of a wood screw inserted through a hole drilled in this flat base section. Thus, when this spring bolt guard, as described above, is placed into the said bolt cavity on the door frame, such that the flat base section bears upon the bottom of the cavity, and the broad base of the “U” bears upon the outermost edge of the strike plate, that is the edge closest to the outside of the door, and is then screwed in place by means of the wood screw through the said base hole, a section of the “U” channel will protrude out from the strike plate and into the free spece of the door gap. This protruding section envelopes most of the sloping section of the spring bolt, which is the outermost part of the spring bolt, and thus prevents any external body reaching the spring bolt.

Since the protruding section of the spring bolt guard should fill the said door gap exactly, and since each door gap may be different, the protruding “U” section must be variable. This variation in the protrusion length is accomplished by varying the depth of the bolt cavity in the frame by using a chisel to remove some wood from the bolt cavity if the protrusion is too long, or by packing the depth of the bolt cavity, using a sliver of wood, if the protrusion is too short to fill the door gap. In the case of a steel or aluminum door the protruding section of the spring bolt guard can be varied in length by either filing or grinding the protrusion if the bolt cavity is not deep enough, or by packing the bolt cavity if it is too deep, and by using a self tapping screw to mount the spring bolt guard in place of the wood screw. However, metal doors are usually assembled with their accompanying frames which provides for a standard door gap and so this is not expected to be a necessary operation.

An object of this invention is the provision of a spring bolt guard which will fill the gap between a door frame and a door edge in such a manner that the sloping surface of a spring bolt lock is protected in all dimensions from any external body inserted into the said door gap.

An object of this invention is the provision of a spring bolt guard which can be adjusted such that variations in door installations such as bolt cavity depth and door gap width can be compensated for. An object of this invention is the provision of a spring bolt guard which will dissipate or deflect a force applied by some external body towards a spring bolt of a spring bolt lock.

An object of this invention is the provision of a spring bolt guard which can be used on any type of door which employs a spring bolt lock. An object of this invention is the provision of a spring bolt guard which is screwed to the bottom of a bolt cavity on a door frame and thus inhibits tampering.

An object of this invention is the provision of a spring bolt guard which by its bearing upon the strike plate on the door frame strengthens the door against an impact force such as kicking or barging.

The above stated and other objects and advantages of the invention will become apparent from the following description when taken with the accompanying drawings and descriptions. It will be understood, however, that the drawings are for purposes of illustration and are not to be construed as defining the scope or limits of the invention, references being had for the latter purpose to the claims appended hereto.

### BRIEF DESCRIPTION OF THE DRAWINGS

In the drawings wherein like reference charachters denote like parts in the several views.

FIG. 1. is aplan view of the spring bolt guard.

FIG. 2. is an elevation view of the spring bolt guard.

FIG. 3. is a view of the spring bolt guard mounted within the bolt cavity as seen when viewing the strike plate mounted on the door frame.

FIG. 4 is a view of the spring bolt guard within the strike plate and showing the protrusion above the door frame which protrusion fills the door gap.

FIG. 5. Shows a plan view of the complete installation of the spring bolt guard as seen from the top of the door.

### DESCRIPTION OF THE PREFERRED EMBODIMENT

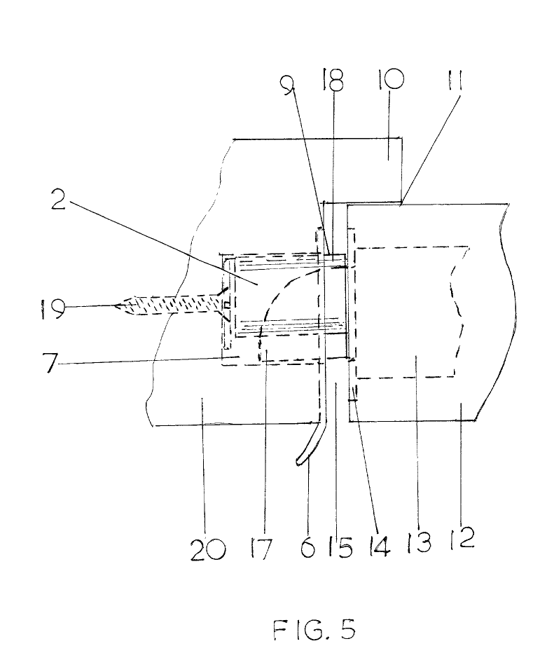

Referring to FIG. 1, the front plate (1) forms the base of the “U” in the “U” channel and the side plates, or flanges, (2) and (3), form the arms of the “U” in the “U” channel. The base of the spring bolt guard (5) is formed by cutting off the side arms of the “U” (2) and (3) at some distance along their length leaving a flat section (5) which is, in turn, bent inwards towards the side arms (2) and (3) such that it forms the base of the spring bolt guard (18) shown as (5) in FIG. 1. A hole (4) is then drilled into this base (5) through which screw (19) is inserted (see FIG. 5) which screw (19) is used to attach the spring bolt guard (18) to the bottom of the bolt cavity cut into the door frame.

FIG. 2, shows a side elevation of the spring bolt guard (18) the side arms (2) and (3) of which are such a length that they include the average depth of the spring bolt cavity cut into the door frame plus the distance between the strike plate mounted on the door frame and the lock mounting plate on the door edge.

FIG. 3, shows a view of the bolt guard (18) mounted within the bolt cavity (7) on the door frame. Front plate (1) bears upon the outside edge (8) of the strike plate (6) hole and the side arms (2) and (3) bear upon the top and bottom egdes of the strike plate (6) hole. The base section (5) sits on the bottom of the bolt cavity (7). Hole (4) is used to screw the assembly on to the frame at the bottom of the bolt cavity (7). Sides (2) and (3) are shown bearing upon the top and bottom edges of the strike plate (6) in this view because a strike plate has been used which has the smallest bolt hole which can possibly be used for a standard spring bolt. With various other shapes and sizes of strike plate bolt holes the side arms (2) and (31 can be bent further outwards, if necessary, to accomodate any variations in the geometry of the installation.

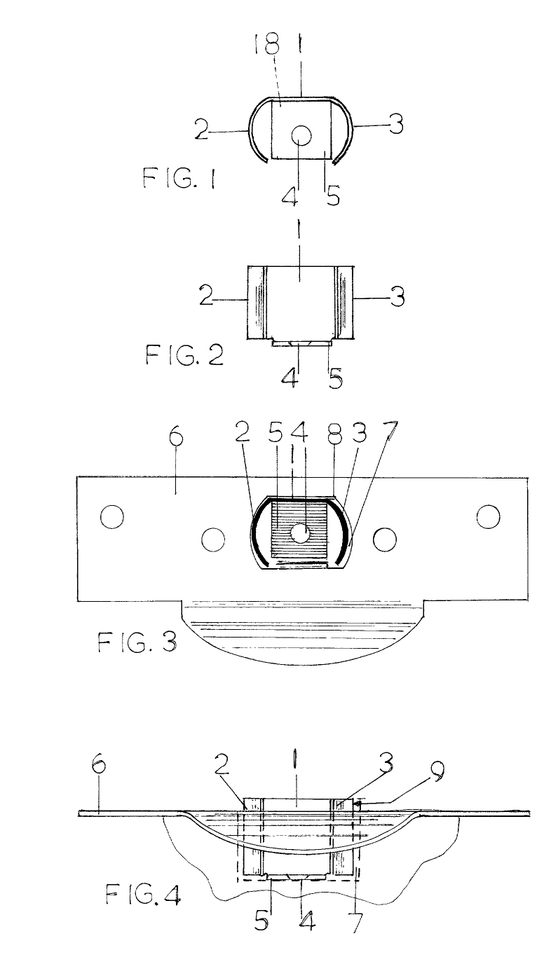

FIG. 4 shows a side elevation, as viewed from the inside edge of the door frame on which the strike plate (6) has been mounted, with a section of the frame removed to show the bolt cavity (7) with the bolt guard (18) in place. The open section of the “U” channel as shown in FIGS. 3 and 4, that is the distance between the top of the side plates (2) and (3), i.e., the top of the “U”, is the section through which the bolt passes when the door is being closed. This view shows the protrusion (9), which is the section which protects the bolt from attack, whose protrusion length is set to match that of the door gap. The door gap is designated here as the distance between the strike plate and mounting plate of the lock.

FIG. 5 shows a complete installation of the spring bolt guard (18) with reference to the frame (20) and the door (12). The strike plate (6) mounted on the frame (20) covers the cavity drilled into the door frame (20). This bolt cavity (7) Contains the spring bolt guard (18) which is screwed to the bottom of the bolt cavity (7) by means of screw (19). Since this FIG. 5 is a plan view of the installation as viewed from the top of the door (12) only the upper side arm (2) of the “U” channel is showing. The spring bolt (17) which is normally held in its extended position by the lock spring (not shown) strikes the strike plate (6) when the door is closing and then proceeds through the gap between the “U” arms (2) and (3) before entering the bolt cavity (7). When some external body is inserted between the architrave (10) and the door (12) at point (11) and the door (12) is pushed in slightly the external body will enter the door gap (15) and bend towards the spring bolt (17). Since spring bolt guard (18) fills this door gap (15) by means of protrusion (9) the external body cannot reach the spring bolt (17), and so cannot force the said bolt back into the lock. Thus the integrity of the spring bolt (17) is maintained.

1. A spring bolt guard device wherein a plastic or metal channel is introduced into a door gap, which hereto is designated as that distance between a strike plate mounted on a door frame and the mounting, or front, plate of a lock mounted on a door, in such a manner that it creates a barrier across the said door gap such that the spring bolt of a spring bolt lock is protected, on all required sides, from external bodies, introduced into the said door gap in order to overcome the lock integrity by forcing the spring bolt back into the lock housing; and wherein this said spring bolt guard device is inserted into a bolt cavity, cut into a door frame, such that the base of the said spring bolt guard device bears upon the the bottom surface of the said bolt cavity in such a manner that the said spring bolt guard device can be screwed on to the said bottom of the bolt cavity.

2. The invention as recited in claim 1 wherein any variations of the bolt cavity depth and also the door gap width can be compensated for by either deepening the bolt cavity, i.e., removing wood from the cavity if the bolt guard device is too long, or by packing the bolt cavity with some material if the bolt guard device is too short.

3. The invention as recited in claim 1 wherein a spring bolt guard device will dissipate, or deflect, any force applied by some external body towards a spring bolt of a spring bolt lock.

4. The invention as recited in claim 1 wherein a spring bolt guard device which by the fact of its being screwed to the bottom of a bolt cavity situated on a door frame inhibits tampering with the device.

5. The invention as recited in claim 1 wherein a spring bolt guard device bears upon the outer edge of a strike plate thus strengthening the door against an impact force such as kicking or barging.

6. The invention as recited in claim 1 through 5 wherein a spring bolt guard device is provided which can be used on any type of door which employs a spring bolt lock.
